(19) United States
(12) Patent Application Publication
(10) Pub. No.: US 2006/0136746 A1
(43) Pub. Date: Jun. 22, 2006

(54) Security system for preventing unauthorized copying of digital data

(76) Inventor: Osama Othman Mostaeen Al-Khateeb, Safat (KW)

Correspondence Address: Michael I. Kroll, 171 Stillwell Lane, Syosset, NY, 11791, US

(21) Appl. No.: 11/015,581

(22) Filed: Dec. 18, 2004

(51) Int. Cl. G06F 12/14

(52) U.S. Cl. 713/189

(57) ABSTRACT

A digital data security system to prevent the unauthorized reproduction thereof by utilizing security hardware integral with the end user recording device and the copying device and security codes impregnated within the data that must correspond with a security code embedded in the disc.

### BACKGROUND OF THE INVENTION

### FIELD OF THE INVENTION

The present invention relates generally to digital media security devices and more specifically, to a digital media security device utilizing hardware and software applications to provide redundant security means to prevent the unauthorized reproduction of software programs, CD's, DVD's, MP3's and other like media that are subject to piracy.

The proliferation of CD and DVD writers has made the unauthorized reproduction of digital media a major problem. Software designers often spend years developing computer programs and they and their licensees rely on the royalties from sales to pay for the development and to gain profit therefrom. Movie companies, actors, music labels, artists and other such entities also depend on the sales royalties to make their living. Unfortunately bootlegging has become commonplace and has greatly reduced the profit margins of the legitimate businesses while the bootleggers have flourished since they can afford to sell the pirated material at a fraction of the cost. Recognizing that something must be done to prevent the unauthorized reproduction of their digital media, manufacturers have attempted to thwart the bootleggers by adding encryption codes and other such security methods in the data to prevent the illegal copying thereof. Unfortunately, many of these measures include passwords, back doors and other such methods that can be compromised by someone knowledgeable in the field and the material still finds its way to the black market.

The present invention seeks to overcome the shortcomings of the prior art by introducing a digital data security system to prevent the unauthorized reproduction thereof by utilizing security hardware integral with the recording device and the copying device and security points impregnated within the data that must correspond with a security code embedded in the disc. The security points also have the address of the embedded security code which must be in that precise location to permit copying to continue. There are no passwords or backdoors that enable hackers to compromise the security and make illegal copies thereby assuring the licensee of maximizing their profit potential.

### DESCRIPTION OF THE PRIOR ART

There are other digital media security devices designed to protect digitally recorded intellectual property. Typical of these is U.S. Pat. No. 4,278,837 issued to R. M. Best on Jul. 14, 1981.

Another patent was issued to K. G. Curran et al. on Jun. 25, 1985 as U.S. Pat. No. 4,525,599. Yet another U.S. Pat. No. 4,573,119 was issued to T. 0. Westheimer et al. on Feb. 25, 1986 and still yet another was issued on Aug. 4, 1987 to R. B. Thomas as U.S. Pat. No. 4,685,055.

Another patent was issued to B. S. Joshi on Aug. 18, 1987 as U.S. Pat. No. 4,688,169. Yet another U.S. Pat. No. 4,796,220 was issued to E. W. Wolfe on Jan. 3, 1989 and still yet another was issued on Sep. 5, 1989 to P. Kobus, Jr. as U.S. Pat. No. 4,864,494.

Another patent was issued to S. Ur on Oct. 22, 1996 as U.S. Pat. No. 5,568,550. Yet another U.S. Pat. No. 6,101,476 was issued to J. Kamatakis, et al. on Aug. 8, 2000. A British patent application was published on Sept. 11, 1985 as U. K. Patent Application GB 2 154 769 to M. J. Shaw. International Publication Number WO 97/40619 was issued on Oct. 30, 1997 to L. H. Charney et al.

R. Harras was issued German Patent No. DE 19602804 on Jul. 31, 1997 and A. D. Umkehrer was issued International Patent No. EP0844549 on May 27, 1998. L. Vince et al. was issued Canadian Patent No. CA 2 361 757 A1 on Aug. 31, 2000.

A microprocessor for executing computer programs which are stored in cipher to prevent software piracy. Such a crypto-microprocessor deciphers the enciphered program piecemeal as it executes it, so that a large enciphered program can be securely executed without disclosing the deciphered program or associated data to persons who have access to the wiring of the computer in which the crypto-microprocessor is a component. Such a device may process valuable proprietary programs and data files which are distributed in cipher on videodiscs, semiconductor memory, or other media without risk of software piracy. Various methods of encryption may be used including methods which result in the cipher of a byte being a complicated function of the byte's address in memory. Each crypto-microprocessor chip may use a unique cipher key or tables for deciphering the program, so that a program that can be executed in one chip cannot be run in any other microprocessor.

Methods and apparatus are disclosed for inhibiting the unauthorized copying of ROM-resident computer software or the like, for example, the audio-visual display of an electronic video game. A protection circuit including encryption/decryption means is coupled between the microprocessor and the ROM-memory and is operable in a first mode to properly encrypt/decrypt the program information according to a first algorithm and in a second mode to prevent proper encryption/decryption. The address-data buses are monitored by the protection circuit to detect an invalid program event, such as may occur when a microprocessor emulator is used to attempt an unauthorized copying or “dumping” of the program information. Upon detection of the invalid program event or “trap condition”, the protection circuit switches to its second operating mode thereby to prevent copying of the decrypted program information.

In a digital computing system with a central processing unit (CPU) and random access memory (RAM), an improved data access limitation and protection subsystem protects data stored within predetermined boundaries of the RAM. An operation code detector detects a unique operation code stored in the RAM and fetched by the CPU, and puts out a signal when the unique operation code is detected. An address latch stores a high and a low digital boundary address put out by the CPU when the address latch is enabled by the signal from the operation code detector. An address comparator compares digital addresses subsequently put out by the CPU with the stored boundary addresses and puts out a signal as the result of the comparison. The address comparator signal controls a switch which enables or disables an address transformer and a bidirectional data transformer. A byte of data written by the CPU to the RAM is encoded by the data transformer, and a byte of data fetched by the CPU from the RAM is decoded by the data transformer; and the digital address location to which the byte of data is written and from which it is fetched is transformed from the digital address generated by the CPU in its normal mode of operation if the digital address of the byte of data within the RAM is not greater than the high boundary address and not less than the low boundary address.

A protection subroutine with a unique reference code is emplaced in a protected software package. The package also contains a validation program. The protection subroutine and validation program connect with an ESD and both the ESD and the program communicate with a secure computer. Upon receipt of inputs of the software serial number and reference code and the ESD identifier, the computer generates a validation code which causes the protection subroutine to command execution of the protected software by its hose computer.

A computer software security system for restricting execution of a computer program to a particular machine, including means for storing a machine identification code in the program and means for determining the presence of the machine identification code in the means for storing during execution of the program. A machine identification code unique to the machine is retrieved and compared with the machine identification code in the program. The system prevents further execution of the program unless both codes are present and match.

An authorized user of the program is allowed to make any number of backup copies of a computer program and to execute each such backup copy on the same authorized machine, but is inhibited from executing either the original or any copy thereof on any other machine. The method is implemented by including a control program with the application program to be copy controlled, which control program causes an interaction and registration of the program during initialization of the program with a central computer. The method includes generating a configuration code based on the configuration of the user's computer and the communication of the configuration code to the central computer. The central computer thereafter generates a permission code based on the communicated configuration code and communicates the permission code back to the user. The permission code is then entered into the user's computer and stored as a part of the control program. Prior to each subsequent execution of the program, a recalculation of the permission code is made by the control program and a comparison of the recalculated and the stored permission codes allows further execution of the program. The configuration code may include special data unique to the user's authorized computer and the recalculation of the permission code may be enabled only by data supplied by the central computers generated permission code. Further, self destruct code may be included in the control code to avoid tampering with the copy control scheme.

A computer based function control system is particularly suited for use as a software security device on the highly popular personal computers or a micro-processor driven function. The system includes an encrypted security message uniquely encoded at predetermined locations within the software or function program. The software or function program includes pre-set errors in it to cause failure of execution of the function or software program unless the errors are nulled during operation of the function or software program. A separate electronic key for retrieving, recognizing, decrypting, encrypting, and producing the null signals is connected to the communications port of the computer from which the key draws its power as well as the security message passed from the computer to the key and back to the computer. There is interchange of moving target and validation information between the computer software and the electronic key. This information is transferred via the security message under the cover of encryption and is monitored by the key and the software to insure that operation of the program can be effected only by authorized users of the function or software program (that is those having the key uniquely associated with that program).

Each copy of software is assigned a unique identifying code pattern which is printed on all documents produced with that software by a high resolution printer. The unique identifying code pattern is a plurality of spaced apart marks having a size no greater than about 300 dpi, and is therefore, at best, barely noticeable to the human observer. The “invisible signature” is also reproduced on documents made by unauthorized copies of software which can therefore be traced. Preferably, the unique identifying code is replicated multiple times over the document using an error correcting code to assure that at least one replication will be clear of matter selected for printing by the software. A high resolution scanner extracts and identifies the code patterns printed on the document. In systems where the software generates a print file for the high resolution printer, print commands for the pattern replications are interspersed with the other print commands making identification and removal of the commands very difficult and not worth the effort since the “invisible signature” does not prevent copying of the software or noticeably detract from the appearance of the finished document.

This Protection System, for PC Software stored in CD-ROM, prevents the illegal copying (hacking) with negligible cost increase of the protected Application. The same CD-ROM that contains the Application Software serves as a “protection key”. The CD-ROM disk undergoes a special treatment during its production phase that results in the generation of the Inspection Ring. This system uses a special method for the verification of the authenticity of the Inspection Ring. The existence of the Inspection Ring along with the use of the authenticity verification procedure make impossible the copying of the CD-ROM disk even with the most advanced recording equipment. This system has many advantages over other protection methods like: excellent protection, transparency to the end-user and very low cost since the “protection-key” is the same CD-ROM disk that contains the Application. This system can be used for the protection of every Application Software for PC compatibles that is stored in a CD-ROM and runs under DOS or Windows environments.

A computer program is supplied together with an identifying element encoded so as to identify the particular program. The identifying element is read by a code reader coupled to the computer and the program causes the computer to read this code and compare it with a corresponding code included in the program, before the program can be run. These arrangements prevent the use in computers of programs which have been made by unauthorized copying

Each copy of software (9) is assigned a unique identifying code pattern (27) which is printed on all documents (19) produced with that software (9) by a high resolution printer (17). The unique identifying code pattern (27) is a plurality of spaced apart marks having a size no greater than about 300 dpi, and is therefore, at best, barely noticeable to the human observer. The “invisible signature” is also reproduced on documents (19) made by unauthorized copies of software (9) which can therefore be traced. Preferably, the unique identifying code (27) is replicated multiple times (271-275) over the document (19) using an error correcting code to assure that at least one replication will be clear of matter selected for printing by the software. A high resolution scannner (21) extracts and identifies the code patterns (271-275) printed on the document (19). In systems where the software (9) generates (39) a print file for the high resolution printer (17), print commands for the pattern replications (271-275) are interspersed (41) with the other print commands making identification and removal of the commands very difficult and not worth the effort since the “invisible signature” does not prevent copying of the software (9) or noticeably detract from the appearance of the finished document (19).

A computer program is supplied together with an identifying element encoded so as to identify the particular program. The identifying element is read by a code reader coupled to the computer and the program causes the computer to read this code and compare it with a corresponding code included in the program, before the program can be run. These arrangements prevent the use in computers of programs which have been made by unauthorised copying.

Each copy of software (9) is assigned a unique identifying code pattern (27) which is printed on all documents (19) produced with that software (9) by a high resolution printer (17). The unique identifying code pattern (27) is a plurality of spaced apart marks having a size no greater than about 300 dpi, and is therefore, at best, barely noticeable to the human observer. The “invisible signature” is also reproduced on documents (19) made by unauthorized copies of software (9) which can therefore be traced. Preferably, the unique identifying code (27) is replicated multiple times (271-275) over the document (19) using an error correcting code to assure that at least one replication will be clear of matter selected for printing by the software. A high resolution scannner (21) extracts and identifies the code patterns (271-275) printed on the document (19). In systems where the software (9) generates (39) a print file for the high resolution printer (17), print commands for the pattern replications (271-275) are interspersed (41) with the other print commands making identification and removal of the commands very difficult and not worth the effort since the “invisible signature” does not prevent copying of the software (9) or noticeably detract from the appearance of the finished document (19).

The protection system used to prevent copying of software involves the generation of a physical defect or change on the storage system, such as the disc or CD-ROM. The data is analysed and the result is documented and stored. When the data is installed for use, it allows a comparison to be made with a similar analysis made of the disc being used. This identifies if the installation disc in authentic or not, and if not blocks the use

The software protection method uses an individual identification word (iw1, . . . iwz) associated with each device (g1, . . . gz) connected to the personal computer (pc) in which the software is installed, converted into a corresponding keyword (kw1, . . . kwz) by a manufacturer's processor (pz) and entered in the device memory (m1, . . . mz) together with the identification word. Both words from each device are listed in a computer user databank (dbb) and a manufacturer databank (dbh), with verification of the identification word and the keyword for each device before corresponding data can be processed via the software.

A method for providing authentication, authorization and access control of software object residing in digital set-top terminals creates a fingerprint (“signature”) for each software object, associates each fingerprint with a service tier, encodes each association and creates an association table containing the information and downloads the association table to the digital set-top terminal. In addition, the method utilizes an entitlement management message, sent to each set-top terminal, indicating what software objects the set-top terminal may utilize, and provides a system routine at the digital set-top terminal that is invoked whenever software object is about to be utilized. The entitlement management message contains the access rights given to a particular set-top terminal, which must match the software object's access requirements for the software object to be utilized. The entitlement management message may also contain set-top terminal resource control access rights that a given software object may utilize. When the software object requires the utilization of a set-top resource, a second conditional access routine may be invoked to determine the authorization rights for using the resource. Measures to protect such means are also described. As such the method provides multiple system cable operators (MSO's) with additional capabilities to maintain secure control of features and applications running on their networks and within the associated set-top terminals.

While these digital data security means may be suitable for the purposes for which they were designed, they would not be as suitable for the purposes of the present invention, as hereinafter described.

### SUMMARY OF THE PRESENT INVENTION

A primary object of the present invention is to provide a method and apparatus for preventing unauthorized reproductions of digital data.

Another object of the present invention is to provide a method and apparatus for pre venting unauthorized reproductions of digital data wherein blank discs such as CD's, DVD's and the like are manufactured with unique readable codes embedded therein.

Yet another object of the present invention is to provide a method and apparatus for preventing unauthorized reproductions of digital data wherein a plurality of security points are integrated with the data to be protected prior to reproduction.

Still another object of the present invention is to provide a method and apparatus for preventing unauthorized reproductions of digital data wherein each security point contains the security code equal to the embedded code and the address (specific location) of the embedded security code in the security area in relation to the starting point of the data area on the disc.

Yet another object of the present invention is to provide a method and apparatus for preventing unauthorized reproductions of digital data wherein the user end standard copy head reaches a security point and reads security code and the address of the embedded security code.

Still yet another object of the present invention is to provide a method and apparatus for preventing unauthorized reproductions of digital data wherein during installation the user end copying device uses a security code reader head in the disc drive to read the embedded security code at the address provided by the security point, the copying device will stop installation if the exact embedded security code is not located at the specific address in the security area as indicated by the security point.

Yet another object of the present invention is to provide a method and apparatus for preventing unauthorized reproductions of digital data that is simple and easy to use.

Still yet another object of the present invention is to provide a method and apparatus for preventing unauthorized reproductions of digital data that is inexpensive to manufacture and operate.

Additional objects of the present invention will appear as the description proceeds.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawings in which:

FIG. 1 is a block diagram of the present invention during the manufacturing stage;

FIG. 2 is a top view of secure data discs of the present invention;

FIG. 3 is an illustrative view of the present invention;

FIG. 4 is a flow chart of the present invention during the manufacturing stage; and

FIG. 5 is a flow chart of the present invention during the end user stage.

### DESCRIPTION OF THE REFERENCED NUMERALS

Turning now descriptively to the drawings, in which similar reference characters denote similar elements throughout the several views, the figures illustrate the Security System for Preventing the Unauthorized Copying of Digital Data of the present invention. With regard to the reference numerals used, the following numbering is used throughout the various drawing figures.

10 Security System for Preventing the Unauthorized Copying of Digital Data

12 digital data disc

14 embedded security code

15 security area of disc

16 copying device

19 security software program

20 security point

22 security code

24 address of 14

25 data

28 standard copy head

30 security code reader head

31 secure data

32 data area of 12

34 start point of 32

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

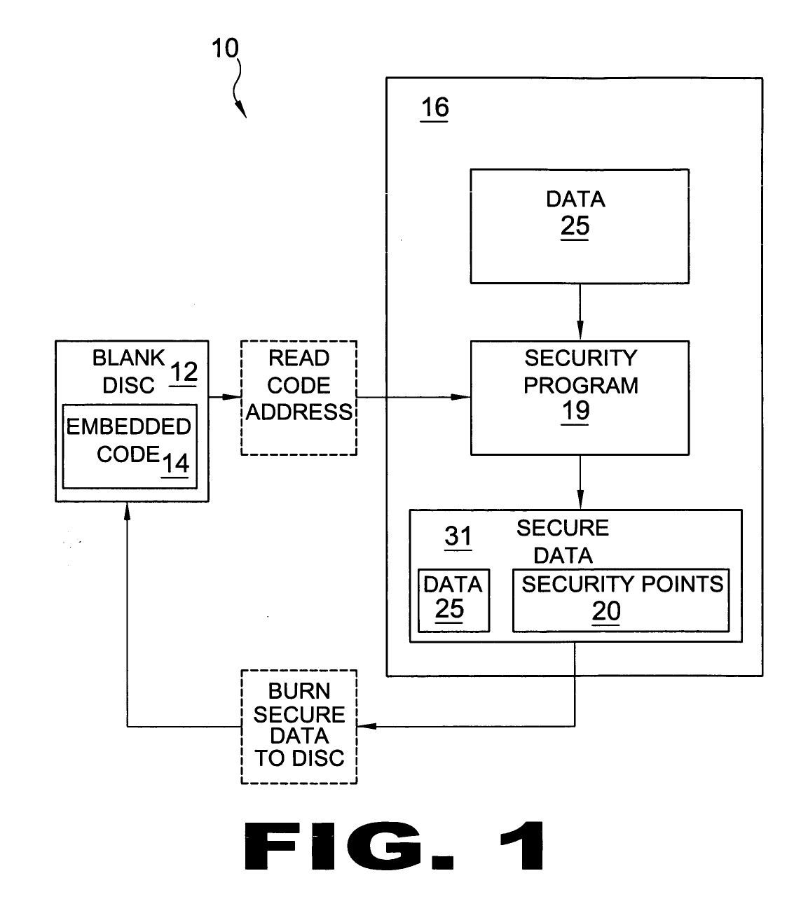

FIG. 1 is a block diagram of the present invention 10 during the manufacturing stage. The data 25 is fed into the manufacturers copy device 16 as is the security software program 19 that is unique to the data 25 to be protected and the embedded security code 14 on the disc 12. The security program 19 uses a security reader head to read the embedded code 14 on the disc 12 and check to ensure that the proper embedded code 14 and data 25 are present. Once verified, the security program 19 will analyze the address (the location of the embedded code 14 relative to the start point of data area on the disc 12) and inserts the security code equal to embedded code 14 and the embedded code address into the security point 20. The security program 19 may insert any number of security points 20 into the data 25 thereby resulting in secure data 31 to be burned through said standard copy head to the disc 12.

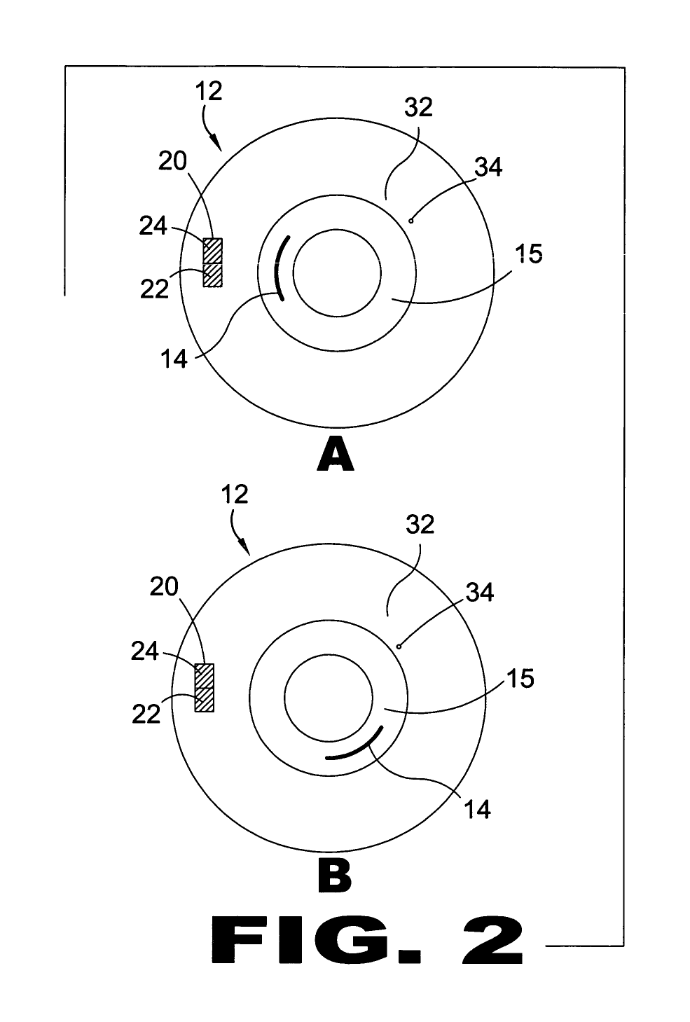

FIG. 2 is a top view of secure digital data discs 12 of the present invention. The embedded security code 14 is randomly disposed in the security area 15 of the disc 12 during manufacture. The security point 20 contains the security code 22 equal to the embedded code 14 and the embedded code address 24 relative to the starting point 34 of the data area 32. Each embedded code address 24 relative to the start point 34 of the data area 32 provides each disc 12 with it's own unique fingerprint due to the random placement of the embedded code 14 in the code area during manufacture as demonstrated by the variation between disc A and disc B thereby making it impossible to copy the secure data from one disc to the other.

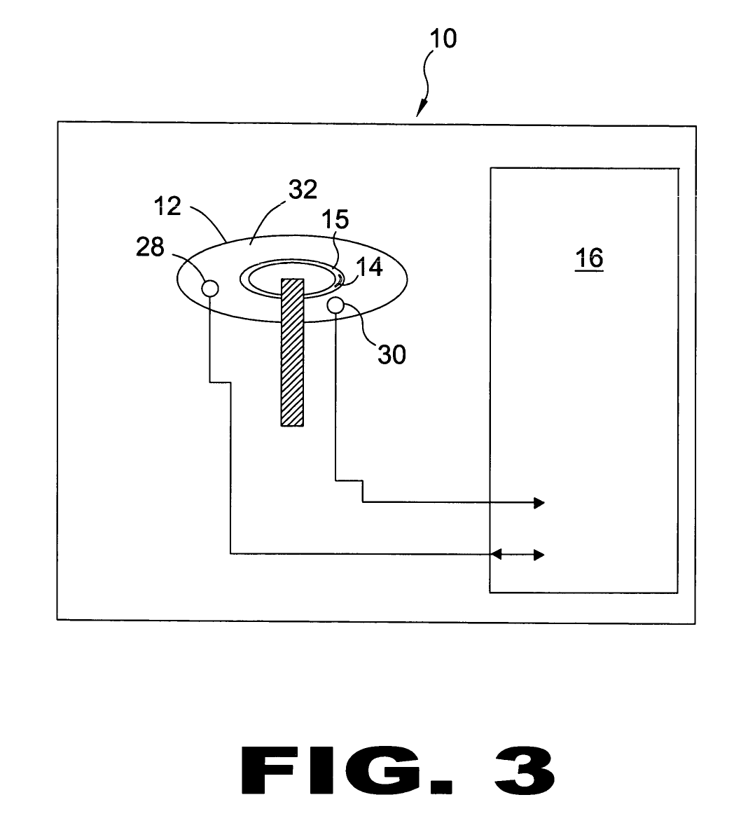

FIG. 3 is an illustrative view of the present invention 10. Shown is the digital data disc 12 in the copying device 16 wherein the standard copy head 28 is used on the manufacturer side to write data and on the user end to read the data and the information provided in each security point in the data area 32 of the disc 12. The security code reader head 30 serves to read the embedded security code 14 at the specified address in the security area 15 of the disc 12.

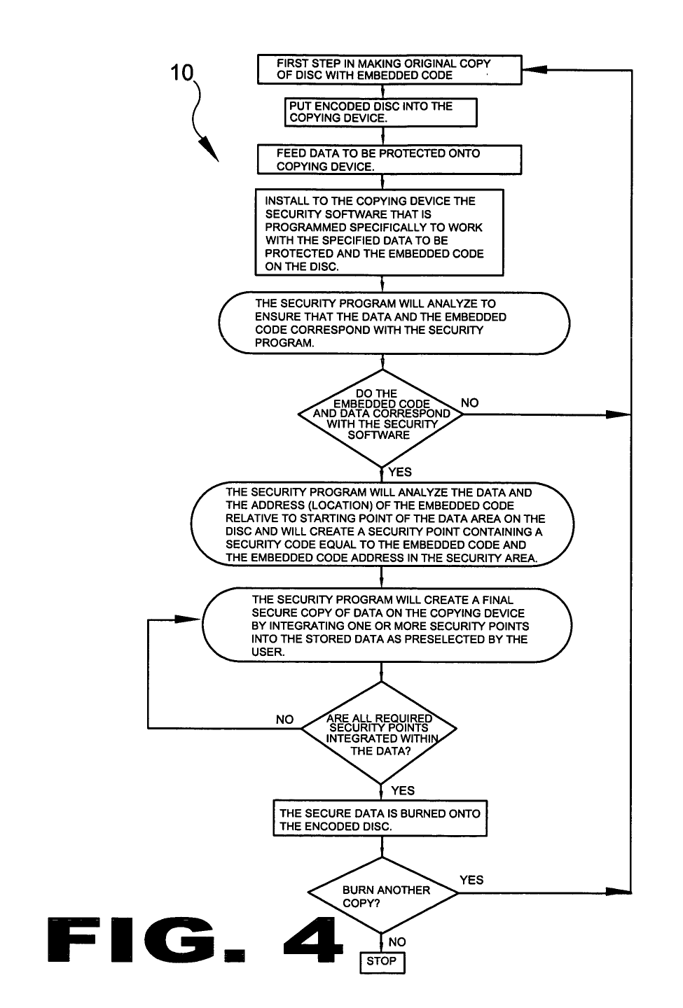

FIG. 4 is a flow chart of the present invention 10 during the manufacturing stage. The present invention 10 starts with blank discs that have an embedded security code thereon that is specific for the program or data that is to be protected. The encoded disc is then placed in the copy device and the data to be protected is loaded onto the copying device. The security program of the present invention is installed onto the copying device. The security program analyzes the data that is to be copied and the embedded code to verify that they are compatible with one another and with the security program and upon verification notes the embedded code address in the security area. The security program inserts the security code equal to the embedded code and it's address into a security point. The security program creates the secure copy by integrating as many security points in the data as is required. Each security point contains the security code equal to the embedded code and the address of the embedded code. Once all of the required security points are verified the secure data may then be copied to disc.

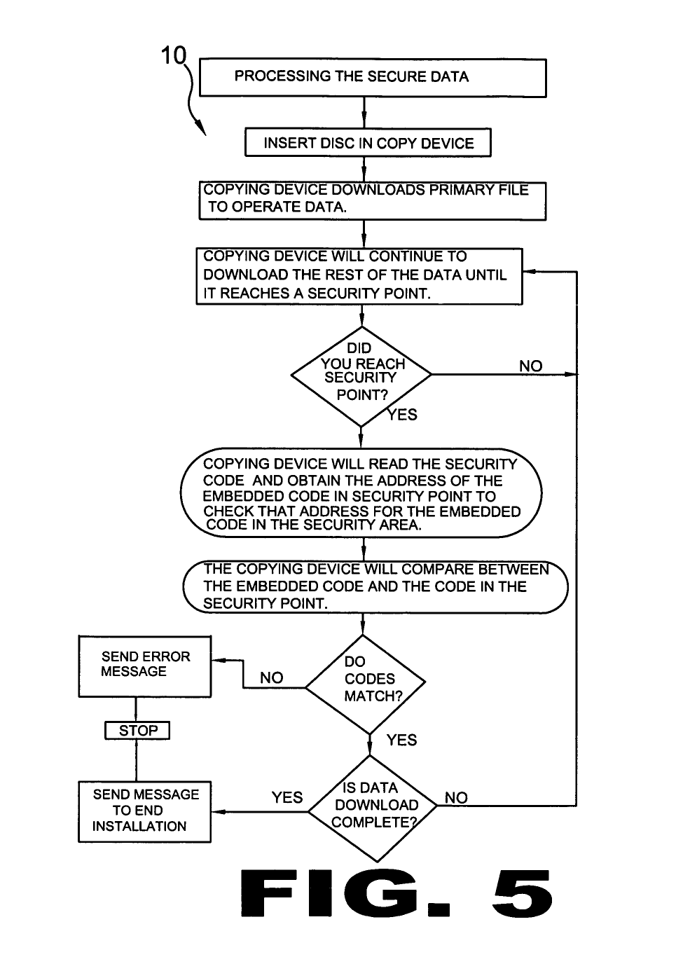

FIG. 5 is a flow chart of the present invention 10 during the end user stage. When the disc is loaded on the user end, the user end copying device downloads the primary file to operate the data. The copying device continues down loading until the standard copy head reaches a security point. The copying device will then read the security code and embedded code address contained in the security point and then compare it with the embedded code at that address. A security reader head is provided specifically to read the embedded security code. If the address provided by the security point is wrong, the security reader head will not find the embedded code and loading will be discontinued. If the address is correct the security reader head will read the embedded code. Any differentiation between the embedded code and the security code provided by the security point will cause the copying device to discontinue the download and send an error message to the user. If the information provided by the security point corresponds to the embedded code, the download will continue. This procedure is repeated each time the standard copy head reaches a security point. Once verification is successful at each security point the installation can be completed and a message sent to the user informing them thereof.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by letters patent is set forth in the appended claims.

1. A security system for preventing the unauthorized copying of digital data comprising:
a) a blank digital data disc manufactured with a security area having an embedded security code randomly located therein, thereby establishing an embedded code address relative to the start point of the data area on said disc;
b) original digital data to be copied to the disc wherein each set of data to be copied has it's own unique corresponding embedded security code address on the discs it is to be copied to;
c) a copying device on the manufacturing end for copying said original data to said disc, said copying device including a standard copy head to write the data and a security reader head to read the embedded security code on said disc;
d) a data specific security software program to be loaded into said copying device for creating and integrating security points into said data, wherein said security program is designed to work specifically with a particular set of data and its corresponding embedded security code;
e) a copying device including a standard copy head on the user end for copying said data from said disc; and
f) means disposed within said user end copying device for reading said embedded security code.

2. A security system for preventing the unauthorized copying of digital data as recited in claim 1, wherein said digital data disc is a compact disc.

3. A security system for preventing the unauthorized copying of digital data as recited in claim 1, wherein said digital data disc is a digital video disc.

4. A security system for preventing the unauthorized copying of digital data as recited in claim 1, wherein said digital data is video.

5. A security system for preventing the unauthorized copying of digital data as recited in claim 1, wherein said digital data is MP3.

6. A security system for preventing the unauthorized copying of digital data as recited in claim 1, wherein said digital data is a software program.

7. A security system for preventing the unauthorized copying of digital data as recited in claim 1, wherein said manufacturer copying device is a computer.

8. A security system for preventing the unauthorized copying of digital data as recited in claim 1, wherein the protected digital data discs are manufactured by:
a) inserting said blank disc with embedded security code into the manufacturers copying device;
b) feeding said original digital data into said copying device;
c) installing said data specific security software program onto said copying device;
d) having the security program analyze the original digital data to be protected and the embedded security code.
e) analyzing the address of the embedded code for inclusion in said security point

9. A security system for preventing the unauthorized copying of digital data as recited in claim 8, wherein any deviation between said security program, said data and said embedded security code will deny verification and require the operator to repeat the procedure from the beginning.

10. A security system for preventing the unauthorized copying of digital data as recited in claim 8, wherein verification of compatibility between said security program, said data and said embedded security code will allow said security program to proceed to create a final secure copy of the data by integrating a pre-selected quantity of security points into said data.

11. A security system for preventing the unauthorized copying of digital data as recited in claim 9, wherein said security program checks the data to verify that all required security points are inserted into said data.

12. A security system for preventing the unauthorized copying of digital data as recited in claim 11, wherein failure to verify the presence of all required security points in said data causes the security program to continue the security point integration process.

13. A security system for preventing the unauthorized copying of digital data as recited in claim 11, wherein verification of a secure copy of said data containing all of the required security points results in the commencement of burning said secure data onto said disc.

14. A security system for preventing the unauthorized copying of digital data as recited in claim 1, wherein each said security point includes the security code that should be equal to the embedded code on said disc and the address of said embedded security code relative to the start of the data area.

15. A security system for preventing the unauthorized copying of digital data as recited in claim 1, wherein said end user copy device is a computer.

16. A security system for preventing the unauthorized copying of digital data as recited in claim 1, wherein said end user copy device is a CD writer.

17. A security system for preventing the unauthorized copying of digital data as recited in claim 1, wherein said end user copy device is a DVD writer.

18. A security system for preventing the unauthorized copying of digital data as recited in claim 1, wherein said reader means in said end user copying device includes a security reader head which is an additional reader head exclusively for reading said embedded security code.

19. A security system for preventing the unauthorized copying of digital data as recited in claim 1, wherein the end user initiates the download of said secure data by inserting the disc into said end user copying device and the primary file will be downloaded to operate the data and the data will continue to download until a security point is reached.

20. A security system for preventing the unauthorized copying of digital data as recited in claim 19, wherein said end user copying device retrieves said security code and its address from said security point via said standard copy head.

21. A security system for preventing the unauthorized copying of digital data as recited in claim 20, wherein said end user copying device compares said security code retrieved from said security point with said embedded security code by using said standard copy head to read said security code and said embedded code address and using said security reader head to read said embedded security code at the address contained in said security point.

22. A security system for preventing the unauthorized copying of digital data as recited in claim 21, wherein the download will cease if no embedded security code is found at said address.

23. A security system for preventing the unauthorized copying of digital data as recited in claim 21, wherein the download will cease if the embedded security code does not match the security code provided by said security point.

24. A security system for preventing the unauthorized copying of digital data as recited in claim 21, wherein the download will continue if the exact security code and address retrieved from said security point matches those of said embedded security code.

25. A security system for preventing the unauthorized copying of digital data as recited in claim 24, wherein the aforementioned verification process will be repeated each time a security point is reached, if every present security point is successfully verified, the download will be complete.

26. A security system for preventing the unauthorized copying of digital data as recited in claim 1, wherein the random placement of the address of said embedded code relative to the starting point of the data area of said disc provides each disc with a unique fingerprint that cannot be duplicated.
